(19) United States
(12) Patent Application Publication
(10) Pub. No.: US 2009/0035155 A1
(43) Pub. Date: Feb. 5, 2009

(54) Axial piston motor

(75) Inventors: Jan Hinrichs, Friedrichsdorf (DE); Andre Speck, Malsch (DE); Peter Barth, Bielefeld (DE)

Correspondence Address: Davidson, Davidson & Kappel, LLC, 485 7th Avenue, 14th Floor, New York, NY, 10018, US

(73) Assignee: ixetic MAC GmbH, Bad Homburg v.d.H. (DE)

(21) Appl. No.: 11/919,089

(22) PCT Filed: Mar. 31, 2006
(86) PCT No.: PCT/DE2006/000577

§ 371 Date: Oct. 23, 2007

(30) Foreign Application Priority Data
Apr. 23, 2005 (DE) 10 2005 019 046.4

(51) Int. Cl. F04B 27/08; F16J 1/00; B23P 15/10; F01B 13/04

(52) U.S. Cl. 417/269; 417/437; 92/208; 29/888.042; 91/499

(57) ABSTRACT

An axial piston motor, particularly an air-conditioning compressor for motor vehicles, including at least one piston with an essentially cylindrical piston skirt and with a wrap-around element, which wraps around a swivel ring or a swash plate and a piston slipper that slides on this swivel ring or this swash plate.

The present invention relates to an axial piston machine, in particular to an air-conditioning compressor for motor vehicles, including at least one piston having a substantially cylindrical piston skirt and a wraparound element that embraces a swivel ring or a swash plate, and piston slippers that slide on this swivel ring or this swash plate that slidably engage thereon.

The present invention also relates to a method for manufacturing a piston of an axial piston machine.

### BACKGROUND

Machines of this kind are generally known. The process of manufacturing the piston wraparound element with the spherical cap-shaped depressions for receiving the piston slippers is associated with narrow tolerances and is difficult from a production standpoint since, once the piston slippers and the swash plate, respectively the swivel ring, have been assembled, the piston slippers must be movable with the least possible clearance within the wraparound element. For the most part, therefore, a high workpiece accuracy, respectively precise selection of the individual parts, is essential.

### SUMMARY OF THE INVENTION

It is an object of the present invention to devise an axial piston machine which will overcome these disadvantages.

The present invention provides an axial piston machine, in particular an air-conditioning compressor for motor vehicles, including at least one piston having a substantially cylindrical piston skirt and a wraparound element that embraces a swivel ring or a swash plate, and piston slippers that slide on this swivel ring or this swash plate, a separate retaining element having a spherical cap-shaped depression for one of the piston slippers being arranged within the wraparound element. An axial piston machine is preferred in which the separate retaining element is adjustable/positionable relative to the wraparound element. Here the advantage is derived that, independently of the manufacturing tolerances of the wraparound element and of the two spherical cap-shaped depressions, the separate retaining element is able to slidably engage without clearance against the piston slippers and the swash plate, and, if indicated, may even squeeze the piston slippers, preloading the same, thereby eliminating the need for complicated machining or even selection processes.

An axial piston machine according to the present invention may provide a retaining element that may be adjustable relative to the wraparound element through the use of a self-locking threaded connection. It may also be beneficial, however, to use a press-fit connection to fasten the retaining element or a welded connection, once the retaining element has been placed in position against the piston slipper.

An axial piston machine is preferred in which, following assembly of one swash plate and two piston slippers, the retaining element may be inserted into the wraparound element and fixed in position substantially without play therein.

In addition, an axial piston machine is preferred in which the wraparound element has a circular opening for receiving the cylindrical piston skirt. Advantageous in this context is the multipiece design of the entire piston, since, for example, the cylindrical piston skirt may be fabricated in a deep-drawing process and the wraparound element in a stamping/bending process, so that the manufacturing method may be adapted to the shape of the individual parts.

In addition, an axial piston machine is preferred, in which the cylindrical piston skirt has a casing and an end cover. Here as well, it may be possible to optimize the fabrication of the individual parts and the different methods associated therewith through the use of a plurality of individual parts.

An axial piston machine according to the present invention may provide the casing with a second spherical cap-shaped depression of the piston for the other piston slipper. Thus, as an individual part, the open casing form allows the spherical cap-shaped depression to be integrally co-formed during the deep-drawing process without entailing substantial outlay for manufacturing.

An axial piston machine is also preferred in which the cover has at least one piston-ring groove. Preferred here again is a method for manufacturing a relatively flat cover component that allows a suitable piston-ring groove to be incorporated into this component.

Also preferred is an axial piston machine in which the wraparound element, the retaining element, the casing and the cover are fabricated from a steel material. The steel material has, in particular, a higher strength and also better wear characteristics than aluminum materials known from the related art, and also facilitates production of thin-walled components.

Equally preferred is an axial piston machine in which the wraparound element, the casing, the end cover and, as the case may be, the retaining element may be laser-welded together, within the spherical cap-shaped depression, the casing having an opening, for example to allow for cleaning subsequently to the welding and abrading processes.

A method is also preferred for manufacturing a piston of an axial piston machine, in particular an air-conditioning compressor for motor vehicles, including at least one piston having a substantially cylindrical piston skirt and a wraparound element that embraces a swivel ring or a swash plate, and piston slippers that slide on this swivel ring or this swash plate, a first piston slipper being inserted into the spherical cap of the casing; the swivel ring or the swash plate being introduced into the wraparound element over the first piston slipper; the second piston slipper being fitted onto the swivel ring, respectively the swash plate, inside of the wraparound element; the retaining element being introduced through the opening into the wraparound element and being brought into contacting engagement with the second piston slipper; and the retaining element being fixed to the wraparound element in this position of contacting engagement, preferably using a fastening method, such as a self-locking thread or a press-fit connection, optionally, however also by a welded or bonded connection. Thus, it is especially advantageous to fit the retaining element onto the swivel ring, respectively the swash plate, in the wraparound element, only after the piston slippers have been installed. This allows the internal clearance in the assembly unit, composed of the swash plate, the piston slipper and the piston, to be optimally adjusted without the need for specially selecting components.

### BRIEF DESCRIPTION OF THE DRAWINGS

The present invention is described below in greater detail with reference to the figures, which show:

FIG. 1 illustrates the piston casing;

FIG. 2 illustrates the piston casing including the cover;

FIG. 3 illustrates the piston casing including the cover and the wraparound element;

FIG. 4 illustrates the piston casing including the cover, the wraparound element, and the first piston slipper;

FIG. 5 illustrates the piston casing including the cover, the wraparound element, the first piston slipper, and a portion of the swivel ring;

FIG. 6 illustrates the piston casing including the cover, the wraparound element, the first piston slipper, a portion of the swivel ring, and the second piston slipper;

FIG. 7 illustrates the entire piston assembly following insertion of the retaining element;

FIG. 8 illustrates an alternative design of the retaining element made of deep-drawn sheet metal.

### DETAILED DESCRIPTION

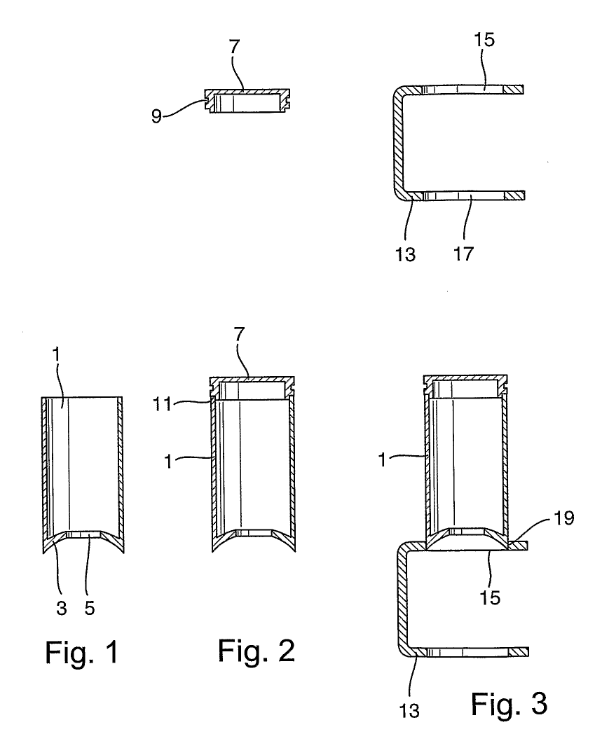

The cylindrical portion of the piston, also referred to as piston casing 1, is shown in cross section in FIG. 1. At its base, casing 1 has a finish-stamped spherical cap 3, which has a circular opening 5 cut out therethrough. In this form, cylindrical piston casing 1 may be fabricated from sheet steel, for example, in a deep-drawing process.

In FIG. 2, a cover part 7 having a circumferentially extending groove 9 for receiving a piston ring is added to the piston casing. It is, of course, equally possible for a plurality of piston grooves to be incorporated into cover 7. The flat disk-type design of this constructional element is again excellently suited for manufacture using a sheet metal working process. In the lower portion of FIG. 2, cover 7 is externally mounted on casing 1 and may be joined to casing 1 in region 11 by a laser weld, for example.

In FIG. 3, piston-wraparound element 13 is added to the assembly unit of FIG. 2. Wraparound element 13 is essentially a U-shaped stamped-bent part having an opening 15 which is able to receive piston casing 1, and an opening 17 into which the retaining element is later inserted. Casing 1 may likewise be joined to wraparound element 13 in region 19 of opening 15 by a laser weld, for example. Therefore, wraparound element 13, whose U-shaped form makes it better suited for a different type of manufacturing method than casing 1 or cover 7, may advantageously be manufactured using a different technique, for example a stamping/bending method, so that the overall construction of the piston is easier to manage from a production standpoint than the manufacture of one-piece aluminum pistons of solid material or of multipiece aluminum pistons as known from the related art.

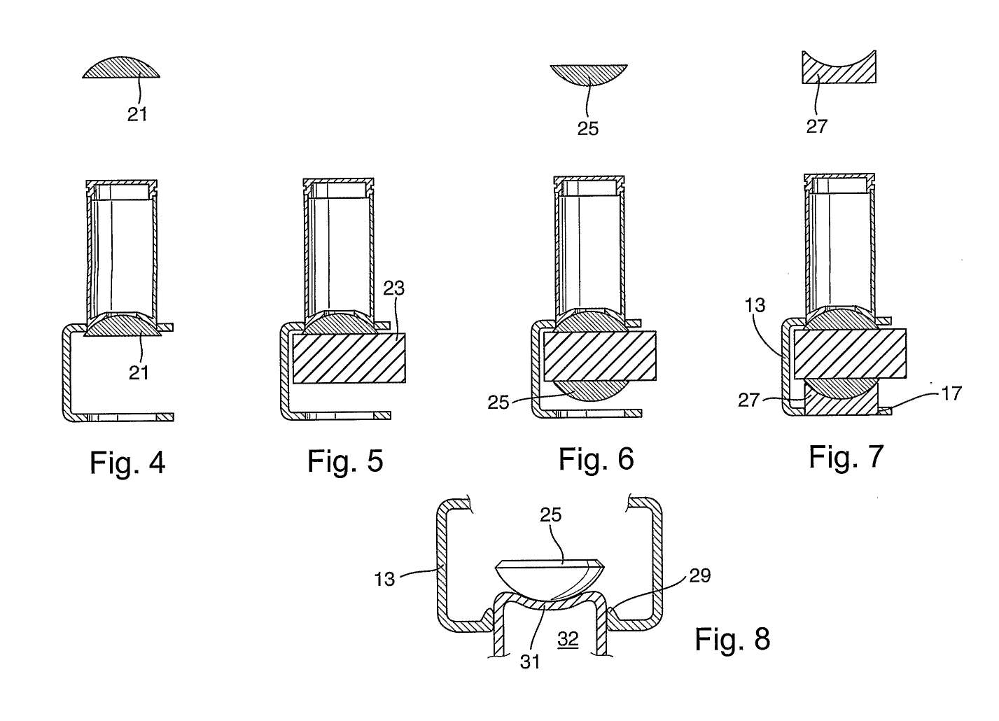

In FIG. 4, first spherical cap 21 is inserted into the now assembled assembly unit of the piston from FIG. 3. Spherical cap 21 fits abuttingly in finish-stamped depression 3 of piston casing 1 of FIG. 1. The option of being able to stamp spherical cap 3 into casing 1 eliminates the need for a costly machine-cutting process to produce this depression.

Following insertion of spherical cap 21 from FIG. 4, a swash plate or swivel ring 23 is introduced into the wraparound element in FIG. 5.

In FIG. 6, second piston slipper 25 is subsequently placed on the other side of the swash plate.

Finally, in FIG. 7, retaining element 27 is introduced through opening 17 of wraparound element 13 and pressed against the two piston slippers and the swivel ring, so that a zero-clearance configuration of the two piston slippers and of the swivel ring within the piston wraparound element is derived in the entire assembly unit. The advantage of the present invention is readily apparent here.

Thus, the assembly unit of an air-conditioning compressor piston composed of a casing 1 having a finish-stamped spherical cap 3, additionally of a cover 7 having a piston-ring groove 9, a U-shaped wraparound element 13 and a retaining segment 27 is provided by the present invention. In this context, depending on the particular advantages desired, different methods may be selected for joining casing 1 to cover 7, on the one hand, and casing 1 to U-shaped wraparound element 13, on the other hand. When sheet metal steel materials are used, it is preferable to employ laser welding processes since the piston must also be able to withstand high forces during the compression work. However, for machine applications which are not carried out at such high pressures, other materials, as well as other fastening methods would also be conceivable. It is possible to consider other aspects when designing the connection of U-shaped wraparound element 13 to retaining element 27. Thus, for example, a threaded connection is conceivable that allows the clearance to be properly adjusted and also readjusted. A self-locking thread prevents the threaded connection from becoming loose during operation.

FIG. 8 shows a variant including a different retaining segment 31 which, in this case, is also a deep-drawn sheet-metal part. Retaining element 31 is inserted in a collar-shaped, formed portion 29 of U-shaped wraparound element 13 and, following clearance-free fitting engagement against the piston slippers, as indicated here by piston slipper 25, may be fixed by a laser weld in regions 32.

### LIST OF REFERENCE NUMERALS

1 piston casing
3 spherical cap
5 circular opening in piston casing 1
7 cover part
9 circumferentially extending groove
11 region for weld
13 piston wraparound element
15 opening in piston wraparound element 13
17 opening for retaining element 27
19 insertion region for piston casing 1 in wraparound element 13
21 first spherical cap (first sliding slipper)
23 swash plate or swivel ring
25 second spherical cap (second piston slipper)
27 retaining element
29 collar-shaped, formed portion of U-shaped wraparound element 13
31 retaining element of deep-drawn sheet-metal part
32 region for laser weld

What is claimed is:

1-11. (canceled)

12: An axial piston machine, in particular an air-conditioning compressor for motor vehicles, comprising:
a swivel ring or a swash plate;
at least one piston having a substantially cylindrical piston skirt;
a wraparound element surrounding the swivel ring or the swash plate; and
a first piston slipper and a second piston slipper slidable on the swivel ring or the swash plate;
a retaining element within the wraparound element, the separate retaining element having a first spherical cap-shaped depression for the first piston slipper.

13: The axial piston machine as recited in claim 12 wherein the separate retaining element is adjustable/positionable relative to the wraparound element.

14: The axial piston machine as recited in claim 13 wherein the retaining element is adjustable relative to the wraparound element using a self-locking threaded connection.

15: The axial piston machine as recited in claim 13 wherein the retaining element is adjustable relative to the wraparound element using a press fit connection.

16: The axial piston machine as recited in claim 13 wherein the retaining element is adjustable relative to the wraparound element using a weld in the desired end position.

17: The axial piston machine as recited in claim 12 wherein following assembly of one of the swivel ring and the swash plate and the first and second piston slippers, the retaining element contacts the wraparound element in a fixed position without play.

18: The axial piston machine as recited in claim 12 wherein the wraparound element has a circular opening for receiving the cylindrical piston skirt.

19: The axial piston machine as recited in claim 12 wherein the cylindrical piston skirt has a casing and an end cover.

20: The axial piston machine as recited in claim 19 wherein the casing has a second spherical cap-shaped depression for the second piston slipper.

21: The axial piston machine as recited in claim 19 wherein the end cover has at least one piston-ring groove.

22: The axial piston machine as recited in claim 19 wherein the wraparound element, the retaining element, the casing and the end cover are a steel material.

23: The axial piston machine as recited in claim 19 wherein the wraparound element, the casing and the end cover are laser welded, the casing having an opening within the spherical cap-shaped depression.

24: A method for manufacturing a piston of an axial piston machine as recited in claim 12, comprising:
inserting the first piston slipper into the spherical cap of the casing;
introducing the swivel ring or the swash plate into the wraparound element over the first piston slipper;
fitting the second piston slipper onto the swivel ring or the swash plate, inside the wraparound element;
introducing the retaining element through the opening into the wraparound element contacting the second piston slipper; and
fixing the retaining element to the wraparound element in the position of contact.

25: The method as recited in claim 24 wherein the retaining element is fixed to the wrap around element by self locking thread.

26: The method as recited in claim 24 wherein the retaining element is fixed to the wrap around element by press fit connection.

27: The method as recited in claim 24 wherein the retaining element is fixed to the wrap around element by a welded connection.
